(19) United States
(12) Patent Application Publication
(10) Pub. No.: US 2011/0081490 A1
(43) Pub. Date: Apr. 7, 2011

(54) METHODS OF CURING POLYUREA PREPOLYMERS FOR GOLF BALLS

(76) Inventors: BRIAN COMEAU, BERKLEY, MA (US); MICHAEL MICHALEWICH, MANSFIELD, MA (US); SHAWN RICCI, NEW BEDFORD, MA (US); DAVID A. BULPETT, BOSTON, MA (US); TIMOTHY S. CORREIA, NEW BEDFORD, MA (US)

(21) Appl. No.: 12/639,097

(22) Filed: Dec. 16, 2009

Related U.S. Application Data
(63) Continuation-in-part of application No. 12/573,349, filed on Oct. 5, 2009.

(51) Int. Cl. B05D 3/12; C08L 75/02; C08K 3/34; C08K 3/26

(52) U.S. Cl. 427/322; 525/123; 524/507; 524/445; 524/451; 524/439; 524/424

(57) ABSTRACT

Multi-piece, solid golf balls having a cover material made from a polyurea or polyurea/urethane hybrid composition are provided. In one version of the method, the cover materials are prepared by forming a polyurea prepolymer which undergoes two curing steps. In the first step, the prepolymer is partially-cured by reacting it with hydroxyl curing agents, amine curing agents, or mixtures thereof. In the second step, the composition is moisture-cured using environmental controls such as humidity chambers or hot water baths. In another version, a polyurea prepolymer is prepared and then treated with an aqueous curative blend comprising an amine curing agent. The cured materials may be used to make a golf ball cover having improved durability, cut/tear resistance, and impact strength.

### CROSS-REFERENCE TO RELATED APPLICATIONS

This application is a continuation-in-part of U.S. patent application Ser. No. 12/573,349 having a filing date of Oct. 5, 2009, the entire disclosure of which is incorporated by reference.

### BACKGROUND OF THE INVENTION

1. Field of the Invention

The present invention relates generally to methods of curing polyurea compositions for use in constructing golf balls. More particularly, in one version, a polyurea prepolymer is prepared and partially-cured with an amine curing agent. The resulting composition is moisture-cured to form a fully-cured polyurea material. Environmental control systems such as humidity chambers and hot water baths may be used to moisture-cure the composition. Alternatively, in a second version, a polyurea prepolymer is prepared and then treated with an aqueous curative blend comprising an amine curing agent. The cured polyurea materials of this invention may be used to make golf ball covers. The finished golf ball has many advantageous properties including improved durability and cut/tear resistance.

2. Brief Review of the Related Art

Multi-piece solid golf balls having an inner core and outer cover with an intermediate layer disposed there between are popular today in the golf industry. The inner core is made commonly of a rubber material such as natural and synthetic rubbers, styrene butadiene, polybutadiene, poly(cis-isoprene), or poly(trans-isoprene). Often, the intermediate layer is made of an ionomer resin that imparts hardness to the ball. These ionomer copolymers contain inter-chain ionic bonding, and are generally made of an olefin such as ethylene and a vinyl comonomer having an acid group such as methacrylic, acrylic acid, or maleic acid. Metal ions such as sodium, lithium, zinc, and magnesium are used to neutralize the acid groups in the copolymer. Commercially available ionomer resins are used in different industries and include numerous resins sold under the trademarks, Surlyn® (available from DuPont) and Escor® and Iotek® (available from ExxonMobil). Ionomer resins are available in various grades and identified based on the type of base resin, molecular weight, type of metal ion, amount of acid, degree of neutralization, additives, and other properties. The cover material may be made of a variety of materials including ionomers, polyamides, polyesters, and thermoplastic and thermoset polyurethane and polyurea elastomers. In recent years, there has been high interest in using thermoset, castable polyurethanes and polyureas to make cover layers. The polyurethane or polyurea cover layer is applied over the ionomer-based intermediate layer to produce a finished golf ball.

For example, Hebert, U.S. Pat. No. 5,885,172 discloses a golf ball having a dual-layered cover. The inner cover is made from a hard material such as an ionomer resin that provides a flex modulus of at least about 65,000 psi. A thin outer cover layer, made from a thermoset castable liquid material such as a polyurethane or polyurea, surrounds the inner cover.

There are different methods for curing polyurethane and polyurea compositions. For example, Milhem, U.S. Pat. No. 6,833,424 discloses a method of forming a polyurea coating composition that can be cured by a “dual cure” mechanism. The method involves mixing a polyisocyanate with polyaspartic ester, wherein the polyisocyanate is present in an amount greater than the normal stoichiometric amount for the polyaspartic ester. Particularly, the polyaspartic ester is “over-indexed” with the polyisocyanate so the ratio of NCO to NH is greater than 1.5 to 1. The mixed composition is applied to a substrate to form a surface coating, and the composition cures after air drying at 72° F./40% relative humidity in less than 120 minutes so that it is “dry to handle.” There is no disclosure, however, for making golf balls or golf ball subassemblies or components for golf balls in U.S. Pat. No. 6,833,424.

Slagel et al., U.S. Patent Application Publication 2009/0105013 discloses methods for making curable polyurethane/polyurea hybrid compositions that can be used as the outer layer and/or at least one inner layer of golf balls. According to the '013 Publication, the ultraviolet (UV) light-resistance of the golf ball layer may be increased when such curable compositions. The methods involve preparing a polyurethane prepolymer that is the reaction product of polyisocyanate, at least one polyol, water, and an optional catalyst. The prepolymer is reacted with at lest one amine curing agent. The '013 Publication discloses that the urea content of the prepolymer may be increased by adding water to the isocyanate reaction chamber when making the prepolymer. Both urea and urethane linkages are found in the prepolymer. The addition of water in the prepolymer phase increases the number of urea linkages in the prepolymer.

Golf balls having an intermediate layer made of a relatively hard ionomer resin and a thin cover layer made of a relatively soft polyurethane or polyurea generally have desirable properties. The relatively hard intermediate layer, along with the core, helps provide a relatively high compression and resiliency to the golf ball. Such golf balls generally have a higher initial velocity and retain more total energy when struck with a club. Players can achieve longer flight distances when using such golf balls. This is particularly desirable when hitting the ball off the tee. The relatively soft polyurethane or polyurea cover layer provides the ball with a softer feel. Golfers can place a spin on the ball and better control its flight pattern. The softer covered golf ball feels more natural when it contacts the club face. The player senses more control, and the softer ball cover tends to have higher initial spin. This is particularly desirable when making approach shots near the hole's green. Skilled players can place a back-spin on such balls so they land precisely on the green. However, one potential disadvantage with using the softer covered golf balls is they may have low shear/cut-resistance and impact strength. As a result, the balls may appear damaged and worn after repeated use.

Thus, it would be desirable to develop a golf ball containing a cover layer made of a composition having good durability and impact strength. The improved cover layer would provide the ball with a combination of good durability and toughness as well as optimum playing performance properties such as feel, softness, spin control, and the like. The present invention provides methods for making such golf balls and the resultant balls.

### SUMMARY OF THE INVENTION

The present invention provides methods for making multi-piece golf balls using polyurea and polyurea/urethane hybrid compositions. In one preferred embodiment, the method involves first preparing a rubber core. A cover layer is formed over the core by: i) mixing an isocyanate compound and amine compound to produce a polyurea prepolymer; ii) chemically-curing the prepolymer by reacting it with an amine-terminated curing agent at a stoichiometric ratio of isocyanate groups to amine groups of at least 1.20:1.00; iii) applying the composition over the core and allowing it to partially-cure; and iv) moisture-curing the composition to form a fully-cured, cover layer comprising a polyurea composition. In a second preferred embodiment, the polyurea prepolymer is chemically-cured by reacting it with a hydroxyl-terminated curing agent at a stoichiometric ratio of isocyanate groups to hydroxyl groups of at least 1.20:1.00. In another version, the polyurea prepolymer is reacted with an amine or hydroxyl-terminated curing agent in the presence of about 0.1 to about 1.0% by weight water. When the polyurea prepolymer is reacted with an aqueous curative blend comprising an amine curing agent, the curing time of the polyurea prepolymer is reduced.

At least one intermediate layer can be disposed between the inner core and outer cover of the ball. The cover layer made with the polyurea or polyurea/urethane hybrid composition of this invention provides the ball with good impact durability and toughness as well as a soft feel. Preferably, the cover layer has a thickness of about 0.020 to about 0.040 inches and a Shore D hardness of about 40 to about 65. In other ball constructions, the composition of this invention is used in the core and/or intermediate layer.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a front view of a dimpled golf ball made in accordance with the present invention;

FIG. 2 is a cross-sectional view of a two-piece golf ball having a polyurea cover made in accordance with the present invention;

FIG. 3 is a cross-sectional view of a three-piece golf ball having a polyurea cover made in accordance with the present invention;

FIG. 4 is a cross-sectional view of a four-piece golf ball having a polyurea cover made in accordance with the present invention; and

FIG. 5 is a FTIR spectral graph showing the amount of water contained in different samples of polyurea formulations.

### DETAILED DESCRIPTION OF THE PREFERRED EMBODIMENTS

The present invention relates to golf balls having a cover material made from a polyurea composition. Polyurea prepolymers are prepared and moisture-cured to form a polyurea composition in accordance with this invention.

Preparation of Polyurea Prepolymer

The present invention relates to golf balls having a cover material made from a polyurea composition. In general, polyurea compositions contain urea linkages formed by reacting an isocyanate group (—N═C═O) with an amine group (NH or NH₂). The chain length of the polyurea prepolymer is extended by reacting the prepolymer with an amine-terminated curing agent. The resulting polyurea has elastomeric properties, because of its “hard” and “soft” segments, which are covalently bonded together. The soft, amorphous, low-melting point segments, formed from the polyamines, are relatively flexible and mobile, while the hard, high-melting point segments, formed from the isocyanate and chain extenders, are relatively stiff and immobile. The phase separation of the hard and soft segments provides the polymer with its elastomeric resiliency. When amine-terminated compounds are used as the curing agent, the resulting polymer contains only urea linkages.

However, if a hydroxyl-terminated curing agent is used, any excess isocyanate groups in the polymer will react with the hydroxyl groups in the curing agent and create urethane linkages. That is, a polyurea/urethane hybrid composition having urea and urethane linkages is produced, which is distinct from a pure polyurea composition. Polyurea/urethane hybrid compositions are described further below.

Any suitable isocyanate known in the art can be used to produce the polyurea prepolymers in accordance with this invention. Such isocyanates include, for example, aliphatic, cycloaliphatic, aromatic aliphatic, aromatic, any derivatives thereof, and combinations of these compounds having two or more isocyanate (—N═C═O) groups per molecule. The isocyanates may be organic polyisocyanate-terminated prepolymers, low free isocyanate prepolymers, and mixtures thereof. The isocyanate-containing reactable component may also include any isocyanate-functional monomer, dimer, trimer, or polymeric adduct thereof, prepolymer, quasi-prepolymer, or mixtures thereof. Isocyanate-functional compounds may include monoisocyanates or polyisocyanates that include any isocyanate functionality of two or more.

Preferred isocyanates include diisocyanates (having two NCO groups per molecule), biurets thereof, dimerized uretdiones thereof, trimerized isocyanurates thereof, and polyfunctional isocyanates such as monomeric triisocyanates. Diisocyanates typically have the generic structure of OCN—R—NCO. Exemplary diisocyanates include, but are not limited to, unsaturated isocyanates such as: p-phenylene diisocyanate (“PPDI,” i.e., 1,4-phenylene diisocyanate), m-phenylene diisocyanate (“MPDI,” i.e., 1,3-phenylene diisocyanate), o-phenylene diisocyanate (i.e., 1,2-phenylene diisocyanate), 4-chloro-1,3-phenylene diisocyanate, toluene diisocyanate (“TDI”), m-tetramethylxylene diisocyanate (“m-TMXDI”), p-tetramethylxylene diisocyanate (“p-TMXDI”), 1,2-, 1,3-, and 1,4-xylene diisocyanates, 2,2′-, 2,4′-, and 4,4′-biphenylene diisocyanates, 3,3′-dimethyl-4,4′-biphenylene diisocyanate (“TODI”), 2,2′-, 2,4′-, and 4,4′-diphenylmethane diisocyanates (“MDI”), 3,3′-dimethyl-4,4′-diphenylmethane diisocyanate, carbodiimide-modified MDI, polyphenylene polymethylene polyisocyanate (“PMDI,” i.e., polymeric MDI), 1,5-naphthalene diisocyanate (“NDI”), 1,5-tetrahydronaphththalene diisocyanate, anthracene diisocyanate, tetracene diisocyanate; and saturated isocyanates such as: 1,4-tetramethylene diisocyanate, 1,5-pentamethylene diisocyanate, 2-methyl-1,5-pentamethylene diisocyanate, 1,6-hexamethylene diisocyanate (“HDI”) and isomers thereof, 2,2,4- and 2,4,4-trimethylhexamethylene diisocyanates, 1,7-heptamethylene diisocyanate and isomers thereof, 1,8-octamethylene diisocyanate and isomers thereof, 1,9-nonamethylene diisocyanate and isomers thereof, 1,10-decamethylene diisocyanate and isomers thereof, 1,12-dodecane diisocyanate and isomer thereof, 1,3-cyclobutane diisocyanate, 1,2-, 1,3-, and 1,4-cyclohexane diisocyanates, 2,4- and 2,6-methylcyclohexane diisocyanates (“HTDI”), isophorone diisocyanate (“IPDI”), isocyanatomethylcyclohexane isocyanate, isocyanatoethylcyclohexane isocyanate, bis(isocyanatomethyl)cyclohexane (i.e., 1,4-cyclohexane-bis(methylene isocyanate)), 4,4′-dicyclohexylmethane diisocyanate (“H₁₂ MDI,” i.e., bis(4-isocyanatocyclohexyl)-methane), 2,4′- and 4,4′-dicyclohexane diisocyanates, 2,4′- and 4,4′-bis(isocyanatomethyl)dicyclohexanes. Dimerized uretdiones of diisocyanates and polyisocyanates include, for example, unsaturated isocyanates such as uretdiones of toluene diisocyanates, uretdiones of diphenylmethane diisocyanates; and saturated isocyanates such as uretdiones of hexamethylene diisocyanates. Trimerized isocyanurates of diisocyanates and polyisocyanates include, for example, unsaturated isocyanates such as trimers of diphenylmethane diisocyanate, trimers of tetramethylxylene diisocyanate, isocyanurates of toluene diisocyanates; and saturated isocyanates such as isocyanurates of isophorone diisocyanate, isocyanurates of hexamethylene diisocyanate, isocyanurates of trimethyl-hexamethylene diisocyanates. Monomeric triisocyanates include, for example, unsaturated isocyanates such as 2,4,4′-diphenylene triisocyanate, 2,4,4′-diphenylmethane triisocyanate, 4,4′,4″-triphenylmethane triisocyanate; and saturated isocyanates such as: 1,3,5-cyclohexane triisocyanate. Preferably, the isocyanate is selected from the group consisting of MDI, H₁₂MDI, PPDI, TDI, IPDI, HDI, NDI, XDI, TMXDI, THDI, and TMDI, and homopolymers and copolymers and mixtures thereof.

When forming a polyurea prepolymer in accordance with this invention, any suitable amine-terminated compound may be reacted with the above-described isocyanate compounds. Such amine-terminated compounds include, for example, amine-terminated hydrocarbons, amine-terminated polyethers, amine-terminated polyesters, amine-terminated polycarbonates, amine-terminated polycaprolactones, and mixtures thereof. The molecular weight of the amine-terminated compound is generally in the range of about 100 to about 10,000. Suitable polyether amines include, but are not limited to, methyldiethanolamine; polyoxyalkylenediamines such as, polytetramethylene ether diamines, polyoxypropylenetriamine, polyoxyethylene diamines, and polyoxypropylene diamines; poly(ethylene oxide capped oxypropylene) ether diamines; propylene oxide-based triamines; triethyleneglycoldiamines; glycerin-based triamines; and mixtures thereof. In one embodiment, the polyether amine used to form the prepolymer is Jeffamine D2000 (Huntsman Corp.). Additional amine-terminated compounds also may be useful in forming the polyurea prepolymers of the present invention including, but not limited to, poly(acrylonitrile-co-butadiene); poly(1,4-butanediol) bis(4-aminobenzoate) in liquid or waxy solid form; linear and branched polyethylene imine; low and high molecular weight polyethylene imine having an average molecular weight of about 500 to about 30,000; poly(propylene glycol) bis(2-aminopropyl ether) having an average molecular weight of about 200 to about 5,000; polytetrahydrofuran bis (3-aminopropyl) terminated having an average molecular weight of about 200 to about 2000; and mixtures thereof (Aldrich Co.). Preferably, the amine-terminated compound is a copolymer of polytetramethylene oxide and polypropylene oxide (Huntsman Corp.)

Chain-Extending of Prepolymer

The polyurea prepolymer can be chain-extended by reacting it with a single curing agent or blend of curing agents as described further below. The curing agents extend the chain length of the prepolymer and build-up its molecular weight. In conventional methods, the polyurea prepolymer and amine curing agent are mixed so the isocyanate and amine groups are mixed at a 1.05:1.00 stoichiometric ratio. In accordance with the present invention, it now has been found that when the polyurea prepolymer and curing agent are mixed so the isocyanate and amine groups are mixed at a stoichiometric ratio of at least 1.20:1.00, preferably in the range of 1.20:1.00 to 3.00:1.00, and more preferably in the range of 1.20:1.00 to 2.00:1.00, and the composition subsequently is moisture-cured, this results in a fully-cured, hardened composition having enhanced physical properties being formed. Particularly, when the isocyanate and curing agent are mixed to provide a ratio (index) of isocyanate groups (—N═C═O) to amine groups (NH or NH₂) of at least 1.20:1.00, and the resulting composition is moisture-cured, a material having improved hardness and toughness is produced. The hardened material may be used as a golf ball cover.

Suitable amine curing agents that can be used in chain-extending the polyurea prepolymer of this invention include, but are not limited to, unsaturated diamines such as 4,4′-diamino-diphenylmethane (i.e., 4,4′-methylene-dianiline or “MDA”), m-phenylenediamine, p-phenylenediamine, 1,2- or 1,4-bis(sec-butylamino)benzene, 3,5-diethyl-(2,4- or 2,6-)toluenediamine or “DETDA”, 3,5-dimethylthio-(2,4- or 2,6-)toluenediamine, 3,5-diethylthio-(2,4- or 2,6-)toluenediamine, 3,3′-dimethyl-4,4′-diamino-diphenylmethane, 3,3′-diethyl-5,5′-dimethyl4,4′-diamino-diphenylmethane (i.e., 4,4′-methylene-bis(2-ethyl-6-methyl-benezeneamine)), 3,3′-dichloro-4,4′-diamino-diphenylmethane (i.e., 4,4′-methylene-bis(2-chloroaniline) or “MOCA”), 3,3′,5,5′-tetraethyl-4,4′-diamino-diphenylmethane (i.e., 4,4′-methylene-bis(2,6-diethylaniline), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-diethyl-5,5′-dichloro-4,4′-diamino-diphenylmethane, or “MDEA”), 3,3′-dichloro-2,2′,6,6′-tetraethyl-4,4′-diamino-diphenylmethane, 3,3′-dichloro-4,4′-diamino-diphenylmethane, 4,4′-methylene-bis(2,3-dichloroaniline) (i.e., 2,2′,3,3′-tetrachloro-4,4′-diamino-diphenylmethane or “MDCA”), 4,4′-bis(sec-butylamino)-diphenylmethane, N,N′-dialkylamino-diphenylmethane, trimethyleneglycol-di(p-aminobenzoate), polyethyleneglycol-di(p-aminobenzoate), polytetramethyleneglycol-di(p-aminobenzoate); saturated diamines such as ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), methylimino-bis(propylamine) (i.e., N-(3-aminopropyl)-N-methyl-1,3-propanediamine), 1,4-bis(3-aminopropoxy)butane (i.e., 3,3′-[1,4-butanediylbis-(oxy)bis]-1-propanamine), diethyleneglycol-bis(propylamine) (i.e., diethyleneglycol-di(aminopropyl)ether), 4,7,10-trioxatridecane-1,13-diamine, 1-methyl-2,6-diamino-cyclohexane, 1,4-diamino-cyclohexane, poly(oxyethylene-oxypropylene)diamines, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, 3,3′-dichloro-4,4′-diamino-dicyclohexylmethane, N,N′-dialkylamino-dicyclohexylmethane, polyoxyethylene diamines, 3,3′-diethyl-5,5′-dimethyl-4,4′-diamino-dicyclohexylmethane, polyoxypropylene diamines, 3,3′-diethyl-5,5′-dichloro-4,4′-diamino-dicyclohexylmethane, polytetramethylene ether diamines, 3,3′,5,5′-tetraethyl-4,4′-diamino-dicyclohexylmethane (i.e., 4,4′-methylene-bis(2,6-diethylaminocyclohexane)), 3,3′-dichloro-4,4′-diamino-dicyclohexylmethane, 2,2′-dichloro-3,3′,5,5′-tetraethyl-4,4′-diamino-dicyclohexylmethane, (ethylene oxide)-capped polyoxypropylene ether diamines, 2,2′,3,3′-tetrachloro-4,4′-diamino-dicyclohexylmethane, 4,4′-bis(sec-butylamino)-dicyclohexylmethane; triamines such as diethylene triamine, dipropylene triamine, (propylene oxide)-based triamines (i.e., polyoxypropylene triamines), N-(2-aminoethyl)-1,3-propylenediamine (i.e., N₃-amine), glycerin-based triamines, (all saturated); tetramines such as N,N′-bis(3-aminopropyl)ethylene diamine (i.e., N₄-amine) (both saturated), triethylene tetramine; and other polyamines such as tetraethylene pentamine (also saturated). The amine curing agents used as chain extenders normally have a cyclic structure and a low molecular weight (250 or less).

In some instances, as mentioned above, a polyurea/urethane hybrid composition may be formed. In these cases, the curing agent used to chain extend the polyurea prepolymer may be selected from the group consisting of hydroxyl-terminated curing agents and mixtures of amine-terminated and hydroxyl-terminated curing agents.

When it is desirable to prepare a polyurea/urethane hybrid composition, hydroxyl-terminated compounds may be used as the curing agent. The hydroxyl-terminated curing agents are preferably selected from the group consisting of ethylene glycol; diethylene glycol; polyethylene glycol; propylene glycol; 2-methyl-1,3-propanediol; 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl)ether; 1,5-pentanediol; 1,6-hexanediol; 1,3-bis-(2-hydroxyethoxy)cyclohexane; 1,4-cyclohexyldimethylol; 1,3-bis-[2-(2-hydroxyethoxy)ethoxy]cyclohexane; 1,3-bis-{2-[2-(2-hydroxyethoxy)ethoxy]ethoxy}cyclohexane; trimethylolpropane; polytetramethylene ether glycol, preferably having a molecular weight from about 250 to about 3900; and mixtures thereof.

When the polyurea prepolymer is reacted with amine-terminated curing agents during the chemical curing step, as described above, the resulting composition is essentially a pure polyurea composition. That is, the composition contains urea linkages having the general structure below.

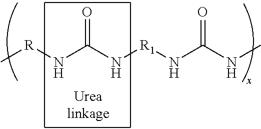

On the other hand, when the polyurea prepolymer is reacted with a hydroxyl-terminated curing agent during the chemical curing step, any excess isocyanate groups in the prepolymer will react with the hydroxyl groups in the curing agent and create urethane linkages. The resulting polyurea/urethane composition contains a mixture of urea linkages (as shown above) and urethane linkages (as shown below):

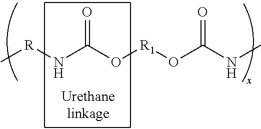

This chemical-curing step, which occurs when the polyurea prepolymer is reacted with hydroxyl-terminated curing agents, amine-terminated curing agents, or mixtures thereof, builds-up the molecular weight and extends the chain length of the prepolymer. When the polyurea prepolymer is reacted with amine-terminated curing agents, a polyurea composition having urea linkages is produced. When the polyurea prepolymer is reacted with hydroxyl-terminated curing agents, a polyurea/urethane hybrid composition having urea and urethane linkages is produced. The polyurea/urethane hybrid composition is distinct from the pure polyurea composition. The concentration of urea and urethane linkages in the hybrid composition may vary. In general, the hybrid composition may contain a mixture of urea and urethane linkages. The resulting polyurea/urethane hybrid composition has elastomeric properties based on phase separation of the soft and hard segments in the polymer.

The compositions of this invention are subjected to a dual-curing process. First, as described above, the polyurea prepolymer is chemically-cured when it is reacted with the amine and/or hydroxyl-terminated chain extenders. Secondly, the resulting composition is moisture-cured in accordance with the steps described below.

Moisture-Curing

The above-described chemical-curing mechanism provides a partially-cured, solid or semi-solid polyurea or polyurea /urethane hybrid composition, which subsequently is fully-cured by contacting the composition with moisture. The resulting fully-cured composition has improved physical properties including toughness, impact durability, and cut/tear-resistance. Different methods may be used for applying the moisture in the moisture-curing step. For example, the partially-cured composition formed by the chemical-curing step may simply be exposed to ambient moisture for a sufficient period to fully-cure the material. Alternatively, a spray of moisture may be applied to the composition so that it fully cures. In another embodiment, the composition is soaked in hot water for one to two hours. In yet another version, the composition is placed in a humidity chamber at relatively high humidity (particularly, the relative humidity (RH) is at least 50%.) Preferably, the humidity chamber has a temperature of 70° C., a relative humidity (RH) of 90%, and the composition is placed in the chamber for one to two hours to achieve good curing of the composition in a relatively short time period.

Different moisture-curing methods may be used in accordance with this invention. In the following Table I, some moisture-curing conditions and curing time periods are described. It should be understood these moisture-curing conditions are illustrative only and not meant to be restrictive.

TABLE I
(Moisture-Curing Conditions and Time to Cure)

| Temperature | Relative Humidity (RH) | Time to Cure | |
|---|---|---|---|
| 22° C. | 50% | 72 | hours |
| 37° C. | 90% | 2-3 | hours |
| 70° C. | 90% | 1-2 | hours |
| 70° C. | Water Bath | 1-2 | hours |

The moisture reacts with the free isocyanate groups to produce carbamic acid. In turn, the relatively unstable carbamic acid decomposes to form carbon dioxide and an amine. The amine then reacts with an isocyanate group in the composition to produce additional urea linkages.

In an alternative embodiment, an aqueous curative blend comprising at least one amine curing agent and water is prepared. The water is present in an amount of about 0.1 to about 1.0% by weight based on total weight of solids in the curative blend. The polyurea prepolymer is then treated with the curative blend. This causes the polyurea prepolymer to cure in a relatively short time period as demonstrated in the below Examples. When the polyurea prepolymer is treated with the aqueous curative blend in accordance with this invention, environmental controls such as humidity chambers and hot water baths (as described above) are not needed. Reacting the polyurea prepolymer with the curative blend causes the prepolymer to cure quickly.

The polyurea or polyurea/urethane hybrid composition may contain additives and other components in amounts that do not detract from properties of the final composition. These additive materials include, but are not limited to, fillers and reinforcing agents such as organic or inorganic particles, for example, clays, talc, calcium, magnesium carbonate, silica, aluminum silicates zeolites, powdered metals, and organic or inorganic fibers; plasticizers such as dialkyl esters of dicarboxylic acids; surfactants; softeners; tackifiers; waxes; ultraviolet (UV) light absorbers and stabilizers; antioxidants; optical brighteners; whitening agents such as titanium dioxide and zinc oxide; dyes and pigments; processing aids; release agents; and wetting agents. In one version, the additives and other components may be added to curative blend which is subsequently reacted with the polyurea prepolymer. In addition, the polyurethane/urea composition may contain additional polymers such as, for example, vinyl resins, polyesters, polyamides, and polyolefins.

A catalyst may be employed to promote the reaction between the isocyanate and amine compounds for producing the prepolymer; or between the prepolymer and curing agent during the chemical-curing step; or between the reactants in the moisture-curing step. Preferably, the catalyst is added to the reactants before producing the prepolymer. Suitable catalysts include, but are not limited to, bismuth catalyst; zinc octoate; stannous octoate; tin catalysts such as bis-butyltin dilaurate, bis-butyltin diacetate, stannous octoate; tin (II) chloride, tin (IV) chloride, bis-butyltin dimethoxide, dimethyl-bis[1-oxonedecyl)oxy]stannane, di-n-octyltin bis-isooctyl mercaptoacetate; amine catalysts such as triethylenediamine, triethylamine, and tributylamine; organic acids such as oleic acid and acetic acid; delayed catalysts; and mixtures thereof. The catalyst is preferably added in an amount sufficient to catalyze the reaction of the components in the reactive mixture. In one embodiment, the catalyst is present in an amount from about 0.001 percent to about 1 percent, and preferably 0.1 to 0.5 percent, by weight of the composition.

Golf Ball Construction

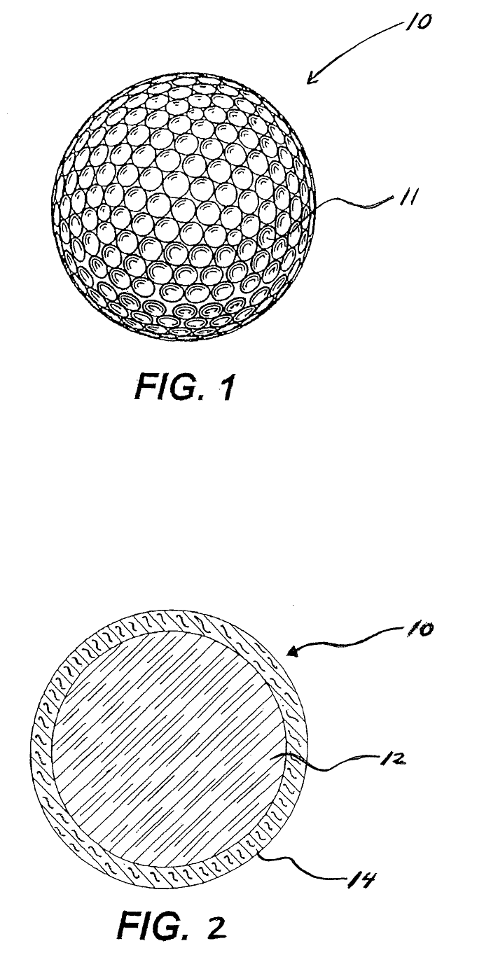

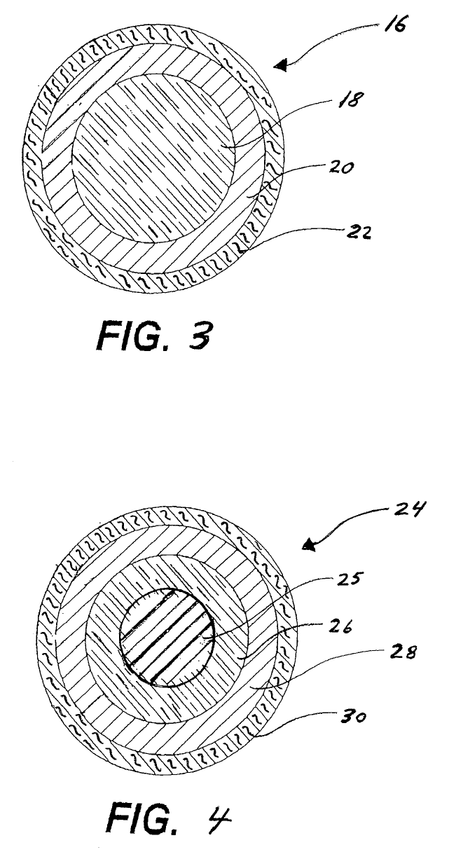

The polyurea and polyurea/urethane compositions of this invention may be used with any type of ball construction known in the art. Such golf ball designs include, for example, two-piece, three-piece, and four-piece designs. The core, intermediate casing, and cover portions making up the golf ball each can be single or multi-layered. In FIG. 1, one version of a golf ball that can be made in accordance with this invention is generally indicated at (10). Various patterns and geometric shapes of dimples (11) can be used to modify the aerodynamic properties of the golf ball (10). The dimples (11) can be arranged on the surface of the ball (10) using any suitable method known in the art. Referring to FIG. 2, a two-piece golf ball (10) having a solid core (12) and polyurea cover (14) of this invention is shown. FIG. 3 shows a three-piece golf ball (16) that can be made in accordance with this invention. In this version, the ball (16) includes a solid core (18), an intermediate casing layer (20), and polyurea cover layer (22). In FIG. 4, a golf ball (24) having a multi-piece core is shown. The multi-piece or multi-layered core includes an inner core (25) and outer core layer (26). The inner core (25) may be made of a first rubber material and the outer core layer (26) may be made of a second rubber material. The first and second rubber materials may have the same or different compositions. The golf ball further includes an intermediate casing layer (28) and polyurea cover layer (30).

Core

The cores in the golf balls of this invention are typically made from rubber compositions containing a base rubber, free-radical initiator agent, cross-linking co-agent, and fillers. The base rubber may be selected from polybutadiene rubber, polyisoprene rubber, natural rubber, ethylene-propylene rubber, ethylene-propylene diene rubber, styrene-butadiene rubber, and combinations of two or more thereof. A preferred base rubber is polybutadiene. Another preferred base rubber is polybutadiene optionally mixed with one or more elastomers such as polyisoprene rubber, natural rubber, ethylene propylene rubber, ethylene propylene diene rubber, styrene-butadiene rubber, polystyrene elastomers, polyethylene elastomers, polyurethane elastomers, polyurea elastomers, metallocene-catalyzed elastomers, and plastomers. The base rubber typically is mixed with at least one reactive cross-linking co-agent to enhance the hardness of the rubber composition. Suitable co-agents include, but are not limited to, unsaturated carboxylic acids and unsaturated vinyl compounds. A preferred unsaturated vinyl is trimethylolpropane trimethacrylate.

The rubber composition is cured using a conventional curing process. Suitable curing processes include, for example, peroxide curing, sulfur curing, high-energy radiation, and combinations thereof. In one embodiment, the base rubber is peroxide-cured. Organic peroxides suitable as free-radical initiators include, for example, dicumyl peroxide; n-butyl-4,4-di(t-butylperoxy)valerate; 1,1-di(t-butylperoxy)3,3,5-trimethylcyclohexane; 2,5-dimethyl-2,5-di(t-butylperoxy)hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Cross-linking agents are used to cross-link at least a portion of the polymer chains in the composition. Suitable cross-linking agents include, for example, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. In a particular embodiment, the cross-linking agent is selected from zinc salts of acrylates, diacrylates, methacrylates, and dimethacrylates. In another particular embodiment, the cross-linking agent is zinc diacrylate (“ZDA”). Commercially available zinc diacrylates include those selected from Rockland React-Rite and Sartomer.

The rubber compositions also may contain “soft and fast” agents such as a halogenated organosulfur, organic disulfide, or inorganic disulfide compounds. Particularly suitable halogenated organosulfur compounds include, but are not limited to, halogenated thiophenols. Preferred organic sulfur compounds include, but not limited to, pentachlorothiophenol (“PCTP”) and a salt of PCTP. A preferred salt of PCTP is ZnPCTP. A suitable PCTP is sold by the Struktol Company (Stow, Ohio) under the tradename, A95. ZnPCTP is commercially available from EchinaChem (San Fransisco, Calif.). These compounds also may function as cis-to-trans catalysts to convert some cis-1,4 bonds in the polybutadiene to trans-1,4 bonds. Antioxidants also may be added to the rubber compositions to prevent the breakdown of the elastomers. Other ingredients such as accelerators (for example, tetra methylthiuram), processing aids, dyes and pigments, wetting agents, surfactants, plasticizers, as well as other additives known in the art may be added to the rubber composition. The core may be formed by mixing and forming the rubber composition using conventional techniques. These cores can be used to make finished golf balls by surrounding the core with outer core layer(s), intermediate layer(s), and/or cover materials as discussed further below.

Intermediate Layer

As shown in FIGS. 3 and 4, the golf balls may include intermediate layers (20, 28), respectively. As used herein, the term, “intermediate layer” means a layer of the ball disposed between the core and cover. The intermediate layer may be considered an outer core layer or inner cover layer, or any other layer disposed between the inner core and outer cover of the ball. The intermediate layer also may be referred to as a casing or mantle layer. The intermediate layer preferably has water vapor barrier properties to prevent moisture from penetrating into the rubber core. The ball may include one or more intermediate layers. In FIGS. 3 and 4, the intermediate layers (20, 28) are shown made of a conventional thermoplastic or thermosetting composition, while each of the respective cover layers (22, 30) is made of the polyurea composition of this invention.

Suitable thermoplastic compositions that can be used to make the intermediate layers (20, 28) include, but are not limited to, partially- and fully-neutralized ionomers, particularly olefin-based ionomer copolymers such as ethylene and a vinyl comonomer having an acid group such as methacrylic, acrylic acid, or maleic acid; graft copolymers of ionomer and polyamide, and the following non-ionomeric polymers: polyesters; polyamides; polyamide-ethers, and polyamide-esters; polyurethanes, polyureas, and polyurethane-polyurea hybrids; fluoropolymers; non-ionomeric acid polymers, such as E/Y- and E/X/Y-type copolymers, wherein E is an olefin (e.g., ethylene), Y is a carboxylic acid, and X is a softening comonomer such as vinyl esters of aliphatic carboxylic acids, and alkyl alkylacrylates; metallocene-catalyzed polymers; polystyrenes; polypropylenes and polyethylenes; polyvinyl chlorides and grafted polyvinyl chlorides; polyvinyl acetates; polycarbonates including polycarbonate/acrylonitrile-butadiene-styrene blends, polycarbonate/polyurethane blends, and polycarbonate/polyester blends; polyvinyl alcohols; polyethers; polyimides, polyetherketones, polyamideimides; and mixtures of any two or more of the above thermoplastic polymers. The olefin-based ionomer resins are copolymers of olefin (for example, ethylene) and α,β-ethylenically unsaturated carboxylic acid (for example, acrylic acid or methacrylic acid) that normally have 10% to 100% of the carboxylic acid groups neutralized by metal cations.

Examples of commercially available thermoplastics include, but are not limited to: Pebax® thermoplastic polyether block amides, commercially available from Arkema Inc.; Surlyn® ionomer resins, Hytrel® thermoplastic polyester elastomers, and ionomeric materials sold under the trade names DuPont® HPF 1000 and HPF 2000, all of which are commercially available from E. I. du Pont de Nemours and Company; Iotek® ionomers, commercially available from ExxonMobil Chemical Company; Amplify® IO ionomers of ethylene acrylic acid copolymers, commercially available from The Dow Chemical Company; Clarix® ionomer resins, commercially available from A. Schulman Inc.; Elastollan® polyurethane-based thermoplastic elastomers, commercially available from BASF; and Xylex® polycarbonate/polyester blends, commercially available from SABIC Innovative Plastics. The additives and filler materials described above may be added to the intermediate layer composition to modify such properties as the specific gravity, density, hardness, weight, modulus, resiliency, compression, and the like.

The ionomeric resins may be blended with non-ionic thermoplastic resins. Examples of suitable non-ionic thermoplastic resins include, but are not limited to, polyurethane, poly-ether-ester, poly-amide-ether, polyether-urea, thermoplastic polyether block amides (e.g., Pebax® block copolymers, commercially available from Arkema Inc.), styrene-butadiene-styrene block copolymers, styrene(ethylene-butylene)-styrene block copolymers, polyamides, polyesters, polyolefins (e.g., polyethylene, polypropylene, ethylene-propylene copolymers, polyethylene-(meth)acrylate, polyethylene-(meth)acrylic acid, functionalized polymers with maleic anhydride grafting, Fusabond® functionalized polymers commercially available from E. I. du Pont de Nemours and Company, functionalized polymers with epoxidation, elastomers (e.g., ethylene propylene diene monomer rubber, metallocene-catalyzed polyolefin) and ground powders of thermoset elastomers.

Cover Layer

As shown in FIGS. 1-4, the cover layers are made of the polyurea composition of this invention. In FIG. 2, the polyurea cover layer (14) is shown immediately encapsulating the core (12). While in FIGS. 3 and 4, the respective polyurea cover layers (22 and 30) are shown enveloping the intermediate casing layers (20 and 28).

It is expected that cover materials made with the polyurea compositions of this invention will have several advantageous properties and benefits. Particularly, the cover materials will show good impact durability and cut/tear-resistance. While not wishing to be bound by any theory, it is believed the dual curing method of this invention provides the golf ball with good mechanical strength.

Golf balls made in accordance with this invention can be of any size, although the USGA requires that golf balls used in competition have a diameter of at least 1.68 inches and a weight of no greater than 1.62 ounces. For play outside of USGA competition, the golf balls can have smaller diameters and be heavier. Preferably, the diameter of the golf ball is in the range of about 1.68 to about 1.80 inches. The core generally will have a diameter in the range of about 1.26 to about 1.60 inches. In one preferred version, the single-piece core has a diameter of about 1.57 inches. The hardness of the core may vary depending upon the desired properties of the ball. In general, core hardness is in the range of about 30 to about 65 Shore D and more preferably in the range of about 35 to about 60 Shore D. The compression of the core is generally in the range of about 70 to about 110 and more preferably in the range of about 80 to about 100. As shown in FIGS. 1-4, the cores generally make up a substantial portion of the ball, particularly, the core may constitute at least 95% or greater of the ball structure.

Referring to FIGS. 3 and 4, which show golf balls having intermediate casing layers, the range of thicknesses for the casing layer can vary because different materials can be used. In general, however, the thickness of the casing layer will be in the range of about 0.015 to about 0.120 inches. More particularly, the thickness of the casing layer may be in the range of about 0.035 to about 0.060 inches.

As shown in FIGS. 1-4 and described above, the cover layer is preferably made of the polyurea composition of this invention. The cover layer should help provide the ball with good mechanical strength and durability as well as optimum playing performance properties. The thickness of the cover layer may vary, but it is generally in the range of about 0.015 to about 0.090 inches. More particularly, if the above-described polyurea composition is used to make the cover layer, the thickness of the cover layer will be in the range of about 0.020 to about 0.040 inches.

The golf balls of this invention may contain layers having the same hardness or different hardness values. In general, the hardness of the surface or material refers to its firmness. The test methods for measuring surface hardness and material hardness are described in further detail below. There can be uniform hardness throughout the different layers of the ball or there can be hardness gradients across the layers. For example, the hardness of the core may vary, but it is generally in the range of about 30 to about 65 Shore D and more preferably in the range of about 35 to about 60 Shore D. The intermediate layer may also vary in hardness in accordance with the present invention. In one embodiment, the material hardness of the intermediate layer is about 45 to about 80 Shore D. Similarly, the hardness of the cover may vary, but it is generally in the range of about 30 to about 65 Shore D.

The polyurea composition produced according to this invention is a castable liquid composition that can be cast to form the cover layer. It is not required, however, that casting methods be used to manufacture the covers. Other suitable manufacturing techniques known in the art also can be used to form the cover, core, and intermediate layers in accordance with this invention. These methods generally include compression molding, flip molding, injection molding, retractable pin injection molding, reaction injection molding (RIM), liquid injection molding (LIM), casting, vacuum forming, powder coating, flow coating, spin coating, dipping, spraying, and the like.

More particularly, the core of the golf ball may be formed using compression molding or injection molding. The intermediate casing layer, which may be made of ionomer resins or other suitable polymers, may be formed using known methods such as retractable pin injection molding or compression molding. The intermediate casing layer is then covered with a cover layer using a casting, compression molding, or injection molding process. Preferably, a casting process is used, wherein the polyurea cover composition is dispensed into the cavity of a first mold member. This first mold half has a hemispherical structure. Then, the cavity of a corresponding second mold member is filled with the same cover composition. This second mold half also has a hemispherical structure. The cavities are typically heated beforehand. A ball cup holds the golf ball (core and overlying casing layer) under vacuum. After the polyurea mixture in the first mold half has reached a semi-gelled or gelled sate, the pressure is removed and the golf ball is lowered into the upper mold half containing the polyurea mixture. Then, the first mold half is inverted and mated with the second mold half containing the polyurea mixture which also has reached a semi-gelled or gelled state. The compositions contained in the mated mold members form the golf ball cover. Next, the mated first and second mold halves containing the cover compositions and golf ball center may be heated. Then, the golf ball is removed from the mold, heated, and cooled as needed. The cover layer is moisture-cured in a subsequent step using the moisture-curing techniques of this invention. The cover may be painted and imprinted with a logo, mark, or other symbol as is customary.

The polyurea composition of this invention may be used with any type of ball construction known in the art. Such golf ball designs include, for example, single-piece, two-piece, three-piece, and four-piece designs. The core, intermediate (casing), and cover portions making up the golf ball each can be single or multi-layered depending upon the desired playing performance properties. As discussed above, in preferred embodiments, the polyurea composition of this invention is used to form a cover layer having improved durability, shear/cut resistance, and impact strength. The cover layer may be single or multi-layered. In other embodiments, the polyurea composition may be used to form a core and/or intermediate layer. That is, the polyurea composition may be used in any golf ball construction so long as at least one layer comprises the composition.

Test Methods

Hardness: The surface hardness of a golf ball layer (or other spherical surface such as a core) is obtained from the average of a number of measurements taken from opposing hemispheres, taking care to avoid making measurements on the parting line of the core or on surface defects such as holes or protrusions. Hardness measurements are made pursuant to ASTM D-2240 “Indentation Hardness of Rubber and Plastic by Means of a Durometer.” Because of the curved surface of the object, care must be taken to ensure that the golf ball or component (for example, a core) is centered under the durometer indentor before a surface hardness reading is obtained. A calibrated digital durometer, capable of reading to 0.1 hardness units, is used for all hardness measurements and is set to take the maximum hardness reading. The digital durometer must be attached to and its foot made parallel to the base of an automatic stand. The weight on the durometer and attack rate conforms to ASTM D-2240. It should be understood there is a fundamental difference between “material hardness” and “hardness as measured directly on a golf ball.” For purposes of the present invention, material hardness is measured according to ASTM D2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of cores and/or cover layers, and the like); ball (or sphere) diameter; and the material composition of adjacent layers. It also should be understood that the two measurement techniques are not linearly related and, therefore, one hardness value cannot easily be correlated to the other.

Compression: In the present invention, “compression” is measured according to a known procedure, using an Atti compression test device, wherein a piston is used to compress a ball against a spring. The travel of the piston is fixed and the deflection of the spring is measured. The measurement of the deflection of the spring does not begin with its contact with the ball; rather, there is an offset of approximately the first 1.25 mm (0.05 inches) of the spring's deflection. Cores having a very low stiffness will not cause the spring to deflect by more than 1.25 mm and therefore have a zero compression measurement. The Atti compression tester is designed to measure objects having a diameter of 1.680 inches; thus, smaller objects, such as golf ball cores, must be shimmed to a total height of 1.680 inches to obtain an accurate reading. Conversion from Atti compression to Riehle (cores), Riehle (balls), 100 kg deflection, 130-10 kg deflection or effective modulus can be carried out according to the formulas given in Compression by Any Other Name, Science and Golf IV, Proceedings of the World Scientific Congress of Golf (Eric Thain ed., Routledge, 2002) (“J. Dalton”).

Coefficient of Restitution (COR): In the present invention, COR is determined according to a known procedure, wherein a golf ball or golf ball subassembly (for example, a golf ball core) is fired from an air cannon at two given velocities and a velocity of 125 ft/s is used for the calculations. Ballistic light screens are located between the air cannon and steel plate at a fixed distance to measure ball velocity. As the ball travels toward the steel plate, it activates each light screen and the ball's time period at each light screen is measured. This provides an incoming transit time period which is inversely proportional to the ball's incoming velocity. The ball makes impact with the steel plate and rebounds so it passes again through the light screens. As the rebounding ball activates each light screen, the ball's time period at each screen is measured. This provides an outgoing transit time period which is inversely proportional to the ball's outgoing velocity. The COR is then calculated as the ratio of the ball's outgoing transit time period to the ball's incoming transit time period (COR=Vₒᵤₜ/Vᵢₙ=Tᵢₙ/Tₒᵤₜ).

The present invention is further illustrated by the following Examples, but these Examples should not be construed as limiting the scope of the invention.

### EXAMPLES

In the following Examples A-F, three-layer, multi-piece golf balls were made. A polybutadiene-based solid core having a diameter of about 1.55 inches was made using conventional techniques. Each core was encapsulated with an ionomer-based intermediate (casing) layer having a thickness of about 0.030 inches so the ball subassemblies had a diameter of about 1.61 inches. Different castable polyurea cover formulations were prepared, and these formulations were cast over the subassemblies to form finished golf balls.

Polyurea Prepolymer Composition Cured with a Diamine

The cover composition was formulated from a polyurea prepolymer composition made from H₁₂MDI (4,4′-dicyclohexylmethane diisocyanate) and amine-terminated polyoxyalkylene. The prepolymer was chemically-cured (chain extended) by reacting it with DETDA (diethyltoluenediamine) (Ethacure 300, a polyamine curing agent). Glacial acetic acid was used as a catalyst at a level of 0.15% by weight. The prepolymer, polyamine curing agent, and catalyst were mixed to prepare different samples, each sample having a different stoichiometric ratio of isocyanate groups to amine groups and mixing temperature as shown in Table II below.

TABLE II

| | Stoichiometric | | |
|---|---|---|---|
| Sample | Ratio | Mixing Temp. | Gel Time |
| A (Comparative) | 1.05:1 | 49° C. | 67 seconds |
| B | 1.25:1 | 49° C. | 71 seconds |
| C | 1.50:1 | 49° C. | 79 seconds |
| D | 1.75:1 | 54° C. | 78 seconds |
| E | 2.00:1 | 60° C. | 83 seconds |
| F | 2.50:1 | 63° C. | 88 seconds |

As shown in the above Table II, in some instances, the stoichiometric ratio of isocyanate groups to amine groups may be at least 1.50:1 in order to increase the time for the composition to gel. Increasing the gel time causes a slight delay in the curing and hardening time for the composition when the mixing temperature is at least 35° C. Thus, premature setting times can be avoided, and the operator is given more time to work with and handle the composition. In one version, the stoichiometric ratio of isocyanate groups to amine groups is at least 1.50:1, the mixing temperature is at least 35° C., and the gel time is at least 70 seconds.

Polyurea Prepolymer Composition Cured in the Presence of Water

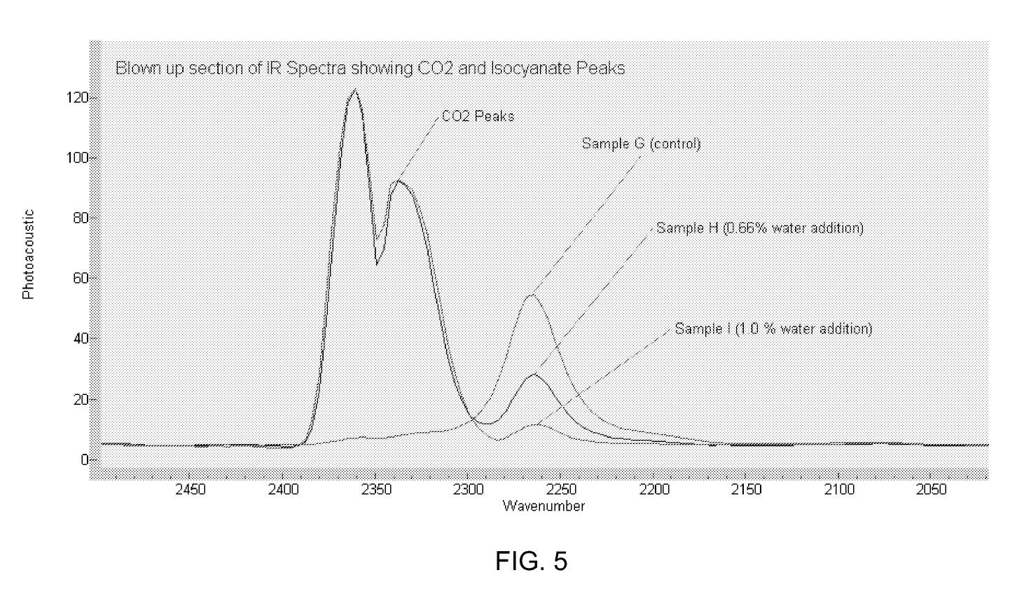

A polyurea prepolymer composition was made from H₁₂MDI (4,4′-dicyclohexylmethane diisocyanate) and amine-terminated polyoxyalkylene. The prepolymer was cured (chain extended) by reacting it with a curative blend comprising water and DETDA (diethyltoluenediamine) (Ethacure 100, a polyamine curing agent). (Sample G was a control sample and reacted only with the DETDA curing agent. The formulation did not contain any water.) Glacial acetic acid was used as a catalyst at a level of 0.15% by weight. The prepolymer, curative blend and catalyst were mixed to prepare different samples, each sample having a different concentration of water. Particularly, Sample G was a control sample and contained no water; Sample H contained 0.66 wt. % water; and Sample I contained 1.0 wt. % water. After four (4) hours, the samples were analyzed using FTIR analysis. As shown in FIG. 5, the peak for the control sample (Sample G) is significantly higher than the peaks for Samples H and I. This shows that the polyurea formulation can be driven to full cure when a polyurea prepolymer is prepared and then reacted with a curing agent and small amount of water.

It is understood that the golf balls described and illustrated herein represent only presently preferred embodiments of the invention. It is appreciated by those skilled in the art that various changes and additions can be made to such golf balls without departing from the spirit and scope of this invention. It is intended that all such embodiments be covered by the appended claims.

We claim:

1. A method of making a golf ball, comprising the steps of:
forming a core, the core having a diameter of about 1.26 to about 1.60 inches and a surface hardness in the range of about 30 to about 65 Shore D, and curing the core;
forming a cover layer, the cover layer having a thickness of about 0.015 to about 0.090 inches and a material hardness in the range of about 40 to about 65 Shore D, over the core by:
i) mixing an isocyanate compound and amine compound to produce a polyurea prepolymer;
ii) curing the prepolymer by reacting it with an aqueous curative blend comprising an amine curing agent to form a polyurea composition and applying the composition over the core.

2. The method of claim 1, wherein the core comprises a polybutadiene rubber composition.

3. The method of claim 2, wherein the rubber composition further comprises a free-radical initiator agent, a cross-linking co-agent, and fillers.

4. The method of claim 2, wherein the composition is peroxide-cured using a peroxide selected from the group consisting of dicumyl peroxide; n-butyl-4,4-di(t-butylperoxy)valerate; 1,1-di(t-butylperoxy)3,3,5-trimethylcyclohexane; 2,5-dimethyl-2,5-di(t-butylperoxy)hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and mixtures thereof.

5. The method of claim 1, wherein the isocyanate compound is selected from the group consisting of MDI, H₁₂MDI, PPDI, TDI, IPDI, HDI, NDI, XDI, TMXDI, THDI, and TMDI, and homopolymers and copolymers and mixtures thereof.

6. The method of claim 1, wherein the amine curing agent is selected from the group consisting of 4,4′-diamino-diphenylmethane; 3,5-diethyl-(2,4- or 2,6-)toluenediamine; 3,5-dimethylthio-(2,4- or 2,6-)toluenediamine; 3,5-diethylthio-(2,4- or 2,6-)toluenediamine: 2,2′-dichloro-3,3′,5,5′-tetraethyl-4,4′-diamino-diphenylmethane; polytetramethyleneglycol-di(p-aminobenzoate); 4,4′-bis(sec-butylamino)-dicyclohexylmethane; and mixtures thereof.

7. The method of claim 1, wherein the curative blend further comprises additives selected from the group consisting of clays, talc, calcium, magnesium carbonate, silica, aluminum silicates zeolites, powdered metals, fibers, plasticizers, surfactants, softeners, tackifiers, waxes, ultraviolet (UV) light absorbers and stabilizers, antioxidants, optical brighteners, whitening agents, dyes and pigments; processing aids; release agents; and wetting agents.

8. The method of claim 1, further comprising the step of forming an intermediate layer over the core so the intermediate layer is disposed between the core and cover layer, the intermediate layer having a thickness in the range of about 0.015 to about 0.120 inches and a material hardness in the range of about 45 to about 80 Shore D.

9. The method of claim 8, wherein the intermediate layer is formed from a thermoplastic or thermoset composition.

10. The method of claim 9, wherein the intermediate layer is formed from a thermoplastic composition selected from the group consisting of ionomers; polyesters; polyester-ether elastomers; polyester-ester elastomers; polyamides; polyamide-ether elastomers, and polyamide-ester elastomers; polyurethanes, polyureas, and polyurethane-polyurea hybrids and mixtures thereof.

11. The method of claim 9, wherein the intermediate layer is formed from a thermoset composition selected from the group consisting of polyurethanes, polyureas, and polyurethane-polyurea hybrids, epoxies, and mixtures thereof.

12. The method of claim 10, wherein the intermediate layer is formed from an olefin-based ionomer copolymer.

13. A method of making a golf ball, comprising the steps of:
forming a core, the core having a diameter of about 1.26 to about 1.60 inches and a surface hardness in the range of about 30 to about 65 Shore D, and curing the core;
forming a cover layer, the cover layer having a thickness of about 0.015 to about 0.090 inches and a material hardness in the range of about 40 to about 65 Shore D, over the core by:
i) mixing an isocyanate compound and amine compound to produce a polyurea prepolymer;
ii) curing the prepolymer by reacting it with an aqueous curative blend comprising a hydroxyl curing agent to form a polyurea/urethane hybrid composition and applying the composition over the core.

14. The method of claim 13, wherein the core comprises a polybutadiene rubber composition.

15. The method of claim 13, further comprising the step of forming an intermediate layer over the core so the intermediate layer is disposed between the core and cover layer, the intermediate layer having a thickness in the range of about 0.015 to about 0.120 inches and a material hardness in the range of about 45 to about 80 Shore D.

16. The method of claim 15, wherein the intermediate layer is formed from an olefin-based ionomer copolymer.
